(19) United States
(12) Patent Application Publication
(10) Pub. No.: US 2020/0370366 A1
(43) Pub. Date: Nov. 26, 2020

(54) SECURITY PROVIDING WINDOWS

(71) Applicant: Pleotint, LLC, Jenison, MI (US)

(72) Inventors: Michael D. Broekhuis, Grand Rapids, MI (US); Harlan Byker, Jenison, MI (US)

(21) Appl. No.: 16/883,741

(22) Filed: May 26, 2020

Related U.S. Application Data
(60) Provisional application No. 62/852,005, filed on May 23, 2019.

(51) Int. Cl. E06B 9/24; G02F 1/137; G02F 1/133

(52) U.S. Cl. CPC E06B 9/24; G02F 1/137; G02F 1/1334; E06B 2009/247; G02F 1/13306

(57) ABSTRACT

A switchable windows and a threat sensing or detection system used together to protect against, minimize or mitigate a threat. The threat sensing or detection system provides a signal that may be used to automatically switch a switchable window to the more scattering or privacy condition when a threat is detected. The switchable window may also be a bullet resistant window. Obstructing the ability to view people on the privacy or what is often referred to in the ballistics industry as the witness side of the switchable windows provides a dramatic level of security, safety and protection from a threat like an active shooter or thieves on the threat side of the windows.

### CROSS-REFERENCE TO RELATED APPLICATION

This application claims priority from U.S. Prov. App. Ser. No. 62/852,005, filed May 23, 2019, entitled “Security Providing Windows” filed May 23, 2019, the entire specification of which is incorporated by reference.

### BACKGROUND OF THE DISCLOSURE

### 1. Field of the Disclosure

The disclosure relates in general to devices and windows, and more particularly, switchable devices and windows in combination with a threat detection system.

### SUMMARY OF THE DISCLOSURE

In an aspect of the disclosure, the disclosure is directed to a window comprising a conductive coating or grid thereon and an electronic circuit, the electronic circuit configured to detect a change due to a shattering event, and providing an output to switch a switchable component to a scattering or privacy condition.

In another aspect of the disclosure, the disclosure is directed to a method comprising the steps of: providing a window that includes a switchable component having a scattering or privacy condition; sensing a shattering event of the window; and switching to a scattering or privacy condition.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the disclosure, and some of the components may have been distorted from actual scale for purposes of pictorial clarity.

The disclosure comprises switchable windows and a threat sensing or detection system used together to protect against, minimize or mitigate a threat. The threat sensing or detection system provides a signal that may be used to automatically switch a switchable window to the more scattering or privacy condition when a threat is detected. The switchable window may also be a bullet resistant window. Obstructing the ability to view people on the privacy or what is often referred to in the ballistics industry as the witness side of the switchable windows provides a dramatic level of security, safety and protection from a threat like an active shooter or thieves on the threat side of the windows.

These windows may be installed in any location such as banks, schools, offices, correctional institutions, convenience stores, gas stations, currency exchange booths, etc. These windows may also be installed in vehicles such as military vehicles, armored cars, police vehicles, taxis, airplanes and limousines.

Any type of electrically activated switchable layer or rapid switching, variable light transmission privacy layer that can change in such a way as to obscure the view through the window may be used in the present disclosure. Preferred switchable layers are polymer dispersed liquid crystal and polymer stabilized cholesteric texture layers and devices.

A threat sensing system may be provided by one more than one of the following: threat pattern recognition system, gunshot detection, gunshot recognition, impact detection, shatter detection and penetration detection.

The threat pattern recognition system may be a camera or surveillance system connected to an intelligent electronic program for recognizing characteristics or patterns that suggest a threat.

Gunshot detection or gunshot recognition may be acoustic. It may be based on a gunshot sound signature or identification as described in many patents; for example U.S. Pat. No. 5,455,868 titled “Gunshot Detector” and U.S. Pat. No. 6,185,153 “System for Detecting Gunshots” and the US patents which reference these patents.

Gunshot detection or gunshot recognition may be optical as described in many patents; for example U.S. Pat. No. 8,809,787 titled “Gunshot Detection System and Method” the US patents which reference this patent.

Gunshot detection or gunshot recognition may be a combination of acoustic and optical as described in many patents; for example U.S. Pat. No. 10,032,351 titled “Systems and Methods Associated with Detection of Indoor Gunfire” the US patents which reference this patent.

Suitable gunshot detection and gunshot recognition systems are commercially available from Shotspotter, Inc of Newark, Calif. However, any reliable means of detecting a gunshot and providing a signal to actuate a switching mechanism may be used.

Impact detectors may involve any kind of impact detection including vibration detectors, seismic detectors, strain gauges, smart shear pins and mechanical fuses.

Shatter detectors or penetration detectors may involve a change in an electrical characteristic of conductive coating or conductive grid or pattern on a substrate of a switchable, preferably bullet resistant window. The change in electrical characteristic may be a change in resistance, capacitance or inductance. The coating or grid may be one or both of the conductive coatings of the switchable device included in the switchable window. The electronic circuit is connected to the conductive coating, grid or pattern incorporated in the window and the circuit is capable of detecting a change due to a shattering event and of providing an output signal that can be used for a variety of purposes including actuating a power supply to switch the switchable component of the window to its more scattering or privacy condition.

The threat sensing or detection system may error on the side of caution in this disclosure as the consequences of a false trigger are so minimal. In most cases the switchable windows can be simply returned to a less scattering or non-privacy or non-obscuring state by for example a manual override or reset of the system.

In some configurations the shatter or penetration detector function is provided by one or more than one of the conductive coatings of the switchable device in the window. While the application of a relatively high voltage like 50 to 150 volts at 60 hertz alternating current is often used to cause the switchable device to be in its' nearly clear, non-privacy state, the charging and discharging current can be monitored in a way so as to detect a shattering or penetration event of a conductive coating. In some configurations a separate electronic circuit can be used to monitor the electrical characteristics of a conductive layer in the device. When a change consistent with threat event is detected the circuit causes the application of the clearing voltage to be discontinued or cause the application of an obscuring voltage and the switchable layer goes to the privacy or secure condition. Alternately the switchable device may be protected from shatter and/or penetration and other means of threat detection may be used to determine if the switchable device should go to the privacy or secure condition.

In some configurations the switchable or actuatable privacy layer of the window is part of a bullet and impact resistant window. Bullet and impact resistant windows are typically made up of multiple substrates such as sheets of glass and/or plastic and multiple interlayers that bond the substrates together. Many constructions of bullet and impact resistant windows are known in the art. A switchable or privacy layer may be included in the multilayer stack and act to allow the bullet and impact resistant window to also be a switchable and/or variable privacy window. The switchable function of the windows of the disclosure include a power supply that allows the window to switch between a non-see-through privacy state and a see-through non-privacy state. The states are typically a highly light scattering or frosted state and a much less light scattering or nearly clear state.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

1. A window comprising a conductive coating or grid thereon and an electronic circuit, the electronic circuit configured to detect a change due to a shattering event, and providing an output to switch a switchable component to a scattering or privacy condition.

2. A method comprising the steps of:
providing a window that includes a switchable component having a scattering or privacy condition;
sensing a shattering event of the window; and
switching to a scattering or privacy condition.
